(19) United States
(12) Patent Application Publication
(10) Pub. No.: US 2025/0106790 A1
(43) Pub. Date: Mar. 27, 2025

(54) CELL SITE DEVICE AND ASSOCIATED CLOCK SYNCHRONIZATION METHOD

(71) Applicant: LITE-ON TECHNOLOGY CORPORATION, Taipei (TW)

(72) Inventor: Chih Wei Su, Taipei (TW)

(21) Appl. No.: 18/884,174

(22) Filed: Sep. 13, 2024

Related U.S. Application Data
(60) Provisional application No. 63/585,612, filed on Sep. 27, 2023.

(51) Int. Cl. H04W 56/00; G06F 1/12

(52) U.S. Cl. CPC H04W 56/001; G06F 1/12

(57) ABSTRACT

A cell site device and an associated clock synchronization method are provided. The cell site device includes a clock synchronizer, a first processing circuit, and a second processing circuit. The clock synchronizer generates a first operation clock and a second operation clock. The first operation clock and the second operation clock have a specific synchronous relationship, and the clock synchronizer is adjusted by a synchronizer setting signal. The first processing circuit generates the synchronizer setting signal according to one of an external clock synchronization source and an internal clock signal. The clock synchronizer respectively transmits the first operation clock and the second operation clock to the first processing circuit and the second processing circuit. The first processing circuit generates a cross-unit periodic synchronization signal and transmits the cross-unit periodic synchronization signal to the second processing circuit.

This application claims the benefit of U.S. provisional application Ser. No. 63/585,612, filed Sep. 27, 2023, the disclosure of which is incorporated by reference herein in its entirety.

### TECHNICAL FIELD

The disclosure relates in general to a cell site device and an associated clock synchronization method, and more particularly to a cell site device and an associated clock synchronization method capable of freely switching clock synchronization sources so that synchronization relationship between processing circuits can be maintained.

### BACKGROUND

Small cells can be considered as base stations developed with distributed radio technology. Mobile operators utilize small cells to extend service coverage in-building and/or outdoors. Small cells are electronic devices that play a significant role in 4G and 5G technologies, and the clock synchronization issue of the small cells is a concern in the present disclosure. In the specification, the clock synchronization may represent frequency, phase, and/or time synchronization.

A radio access network (RAN) decomposition classifies RAN's functions into a radio unit (hereinafter, RU) component, a distributed unit (hereinafter, DU) component, and a central unit (hereinafter, CU) component. The distribution of the RAN functions across the RU component, DU component, and CU component is dependent on the RAN functional split option, and the RAN functional split operation may vary in practical applications.

Clock synchronization (for example, frequency synchronization, time synchronization, and phase synchronization) is an essential requirement for cell site devices. In the specification, the clock synchronization sources of the RU component, DU component, and CU component in a cell site device having an all-in-one structure are concerned.

FIG. 1 (prior art) is a schematic diagram illustrating the clock synchronization approach adopted in a conventional cell site device. The cell site device 10 includes a global positioning system (hereinafter, GPS) receiver 102, a GPS antenna 102a, processing circuits 101, 103, and a network interface circuit 104. The network interface circuit 104 includes a media access control (hereinafter, MAC) and port physical layer (hereinafter, PHY) integrating a timestamp unit (hereinafter, TSU).

The cell site device 10 is in communication with a GPS satellite 11, and the cell site device 10 is in communication with or electrically connected to a mobile network 15. The GPS receiver 102 is electrically connected to the GPS antenna 102a and the processing circuit 101. The processing circuit 103 is electrically connected to the processing circuit 101 and the network interface circuit 104.

The GPS antenna 102a receives GPS signal GPS_SIG from a GPS satellite 11. Then, the GPS receiver 102 generates a processing-circuit clock CLK1 according to the synchronization-related information embedded in the GPS signal GPS_SIG. Based on the processing-circuit clock CLK1, the processing circuit 101 performs operations related to the CU component and DU component.

After receiving network signal netSIG from the mobile network 15, the network interface circuit 104 generates another processing-circuit clock CLK2, according to the synchronization-related information acquired from the network signal netSIG. Based on the processing-circuit clock CLK2, the processing circuit 103 performs the RU component-related operations and transmits radio frequency (RF) signals to user equipment (hereinafter, UE) 17. The cell site device 10 is in communication with one or more user equipment 17.

As illustrated above, the processing circuits 101, 103 respectively receive synchronization-related information from the GPS satellite 11 and the mobile network 15. After the processing circuits 101, 103 respectively operate based on the processing-circuit clocks CLK1, CLK2, the processing circuits 101, 103 need to exchange synchronization-related information to ensure the CU/DU/RU components can communicate with each other smoothly.

In the case that the cell site device 10 is placed indoors or outdoors but the GPS signal GPS_SIG is blocked by tall buildings, the GPS signal GPS_SIG is weak, and the GPS antenna 102 cannot receive the GPS signal GPS_SIG correctly. This implies that the processing circuit 101 is incapable of receiving the processing-circuit clock CLK1, and the processing circuits 101, 103 cannot exchange the synchronization-related information.

To be more specific, synchronization accuracy is crucial for communications between the cell site device 10 and the UEs. However, the conventional cell site device 10 cannot provide a stable synchronization relationship between the processing-circuit clocks CLK1, CLK2. Once the processing-circuit clocks CLK1, CLK2 cannot be synchronized, the synchronization issues between the cell site device 10 and the UEs occur.

### SUMMARY

The disclosure is directed to a cell site device and an associated clock synchronization method.

According to one embodiment, a cell site device in a radio access network is provided. The cell site device includes a clock synchronizer, a first processing circuit, and a second processing circuit. The clock synchronizer generates a first operation clock and a second operation clock. The first processing circuit is electrically connected to the clock synchronizer. The first processing circuit receives the first operation clock, generates a synchronizer setting signal, transmits the synchronizer setting signal to the clock synchronizer, and generates a cross-unit periodic synchronization signal. The second processing circuit is electrically connected to the clock synchronizer and the first processing circuit. The second processing circuit receives the second operation clock from the clock synchronizer, and receives the cross-unit periodic synchronization signal from the first processing circuit.

According to another embodiment, a clock synchronization method applied to a cell site device in a radio access network is provided. The cell site device includes a clock synchronizer, a first processing circuit, and a second processing circuit. The clock synchronization method includes the following steps. The clock synchronizer generates a first operation clock and a second operation clock. The clock synchronizer transmits the first operation clock to the first processing circuit and transmits the second operation clock to the second processing circuit. The first processing circuit generates a synchronizer setting signal according to one of an external clock synchronization source and the first operation clock. The first processing circuit generates a cross-unit periodic synchronization signal. The first processing circuit transmits the cross-unit periodic synchronization signal to the second processing circuit.

### BRIEF DESCRIPTION OF THE DRAWINGS

FIG. 1 (prior art) is a schematic diagram illustrating the clock synchronization approach adopted in a conventional cell site device.

FIG. 2 is a block diagram schematically illustrating the cell site device according to an embodiment of the present disclosure.

FIG. 3 is a state diagram schematically illustrating how the cell site device, according to an embodiment of the present disclosure, operates.

FIG. 4 is a schematic diagram illustrating that an oscillator is utilized as the clock synchronization source during the system initialization state.

FIG. 5 is a schematic diagram illustrating that the GPS-based periodic synchronization signal GPS_1pps can be acquired from the GPS signal GPS_SIG, and the synchronization source selector determines to use the GPS-based clock synchronization.

FIG. 6A is a schematic diagram illustrating that the PTP timestamps PTP_tstmp can be acquired from the network signal netSIG, and the synchronization source selector determines to use the PTP-based clock synchronization.

FIG. 6B is a schematic diagram illustrating that the syncE clock signal syncE_CLK can be acquired from the network signal netSIG and the synchronization source selector determines to use the syncE-based clock synchronization.

FIG. 7 is a schematic diagram illustrating that the cell site device is in the stable clock synchronization state using GPS-based clock synchronization.

FIG. 8A is a schematic diagram illustrating that the cell site device is in the stable clock synchronization state using the PTP-based clock synchronization.

FIG. 8B is a schematic diagram illustrating that the cell site device is in the stable clock synchronization state using the syncE-based clock synchronization.

FIG. 9 is a schematic diagram illustrating that the cell site device is in the stable clock synchronization state using oscillator-based clock synchronization.

FIGS. 10A and 10B are flow diagrams schematically illustrating how the cell site device, according to an embodiment of the present disclosure, switches the clock synchronization source.

FIG. 11 is a flow diagram schematically illustrating the clock synchronization method applied to the cell site device according to an embodiment of the present disclosure.

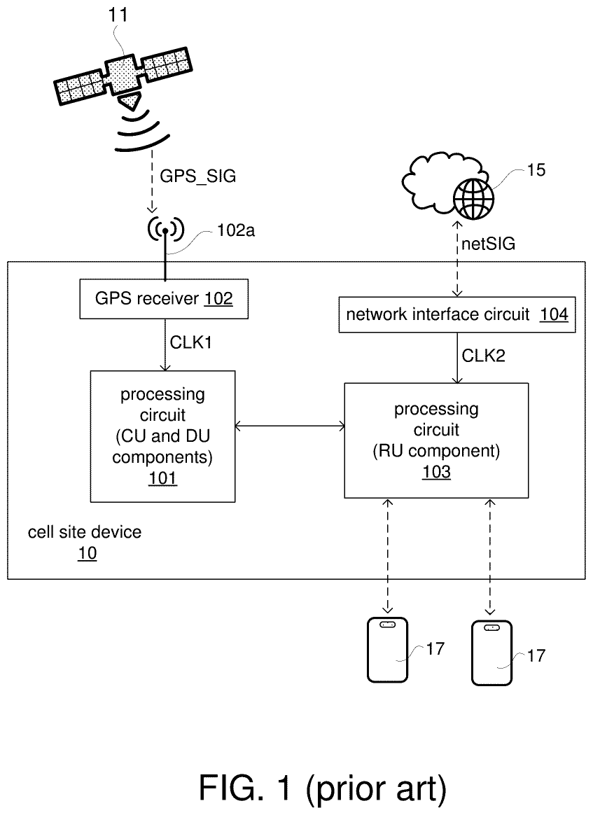

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

To avoid the situation that CU/DU/RU components cannot communicate with each other when any of the external synchronization sources malfunctions, the present disclosure provides an alternate approach to clock synchronization. The clock synchronization approach is implemented based on the combination of various external/internal clock synchronization sources.

The external clock synchronization source can be, for example, a global navigation satellite system (hereinafter, GNSS) and/or network. The network clock source can be, for example, a precision time protocol (hereinafter, PTP) clock source, synchronous Ethernet (hereinafter, syncE) clock source, and so forth. The internal clock synchronization source can be, for example, an oscillator.

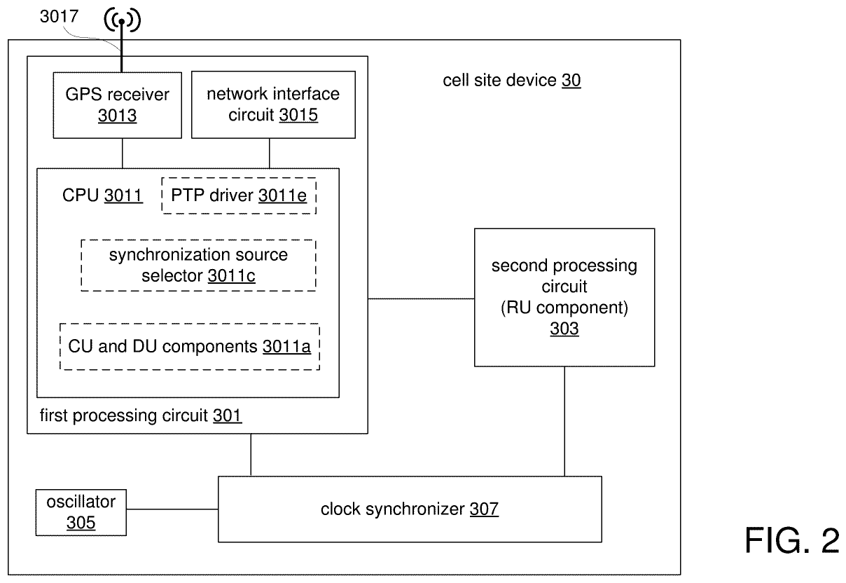

FIG. 2 is a block diagram schematically illustrating the cell site device according to an embodiment of the present disclosure. The internal components of the cell site device 30 and their connections are first introduced.

The cell site device 30 includes a first processing circuit 301, a second processing circuit 303, an oscillator 305, and a clock synchronizer 307. The first processing circuit 301 and the second processing circuit 303 can be implemented with software, hardware, or a combination of software and hardware.

The first processing circuit 301 further includes a central processing unit (hereinafter, CPU) 3011, a global positioning system (hereinafter, GPS) receiver 3013, a GPS antenna 3017, and a network interface circuit 3015. The CPU 3011 executes software programs, including a PTP driver 3011e, a synchronization source selector 3011c, CU and DU components 3011a, and so forth. In practical applications, the PTP driver 3011e, the synchronization source selector 3011c, CU and DU components 3011a can be implemented with software, hardware, or a combination of software and hardware.

The clock synchronizer 307 is electrically connected to the oscillator 305, the first processing circuit 301, and the second processing circuit 303. The GPS receiver 3013 is electrically connected to the GPS antenna 3017 and the CPU 3011. The network interface circuit 3015 is electrically connected to the CPU 3011.

According to an embodiment of the present disclosure, the synchronization source selector 3011c can freely change the clock synchronization source of the cell site device 30. The clock synchronization source can be the GNSS system, PTP, syncE, and/or the oscillator 305.

The GNSS system can be, for example, a global positioning system (hereinafter, GPS), a Galileo system, or a BeiDou Navigation Satellite System. For illustration purposes, the GPS is selected as an exemplary GNSS system.

Basically, the clock synchronization source having better precision accuracy is preferable. As the precision accuracy of the GPS-based clock synchronization is better than the precision accuracy of the PTP-based clock synchronization, the precision accuracy of the PTP-based clock synchronization is better than the precision accuracy of the syncE-based clock synchronization, and the precision accuracy of the syncE-based clock synchronization is better than the precision accuracy of the oscillator-based clock synchronization, the synchronization source selector 3011c will choose the GPS-based clock synchronization first, then the PTP-based clock synchronization, then the syncE-based clock synchronization, and finally the oscillator-based clock synchronization.

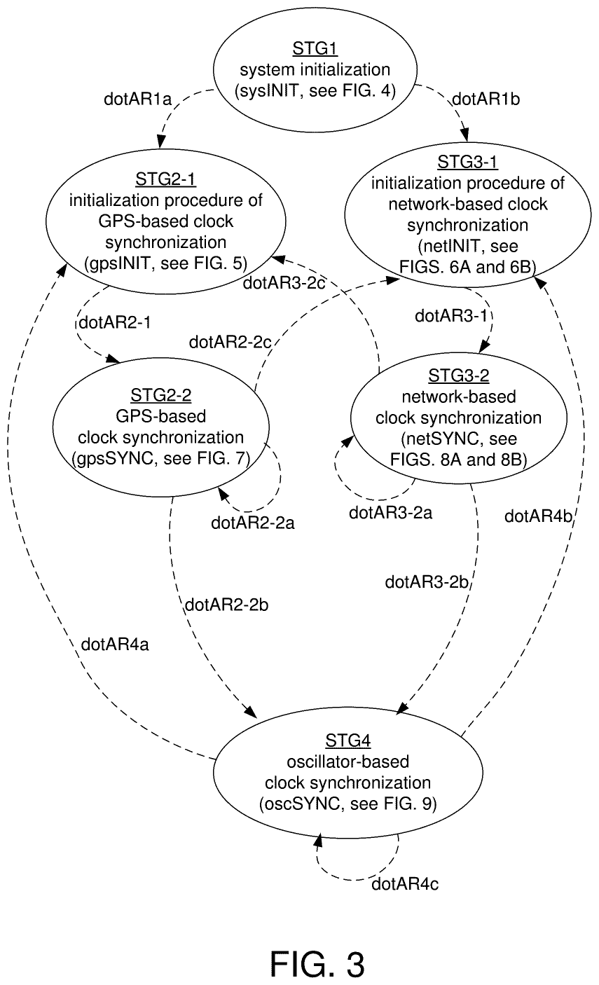

FIG. 3 is a state diagram schematically illustrating how the cell site device, according to an embodiment of the present disclosure, operates. In FIG. 3, the ellipses represent various initialization states (STG1, STG2-1, STG3-1) and clock synchronization states (STG2-2, STG3-2, STG4) of the cell site device 30, and the dotted arrows (dotAR1a, dotAR1b, dotAR2-1, dotAR2-2a, dotAR2-2b, dotAR2-2c, dotAR3-1, dotAR3-2a, dotAR3-2b, dotAR3-2c, dotAR4a, dotAR4b, dotAR4c) represent transition directions between the states. Table 1 summarizes the initialization/clock synchronization states and steps shown in FIG. 3.

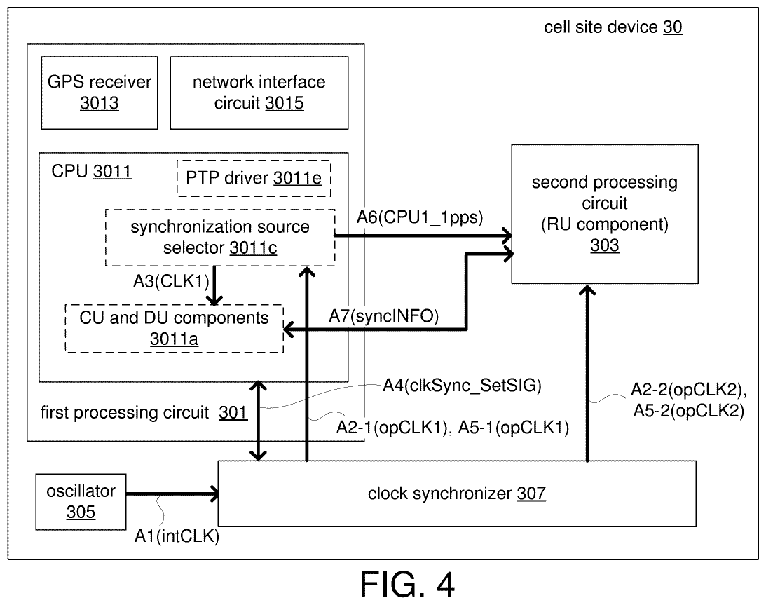

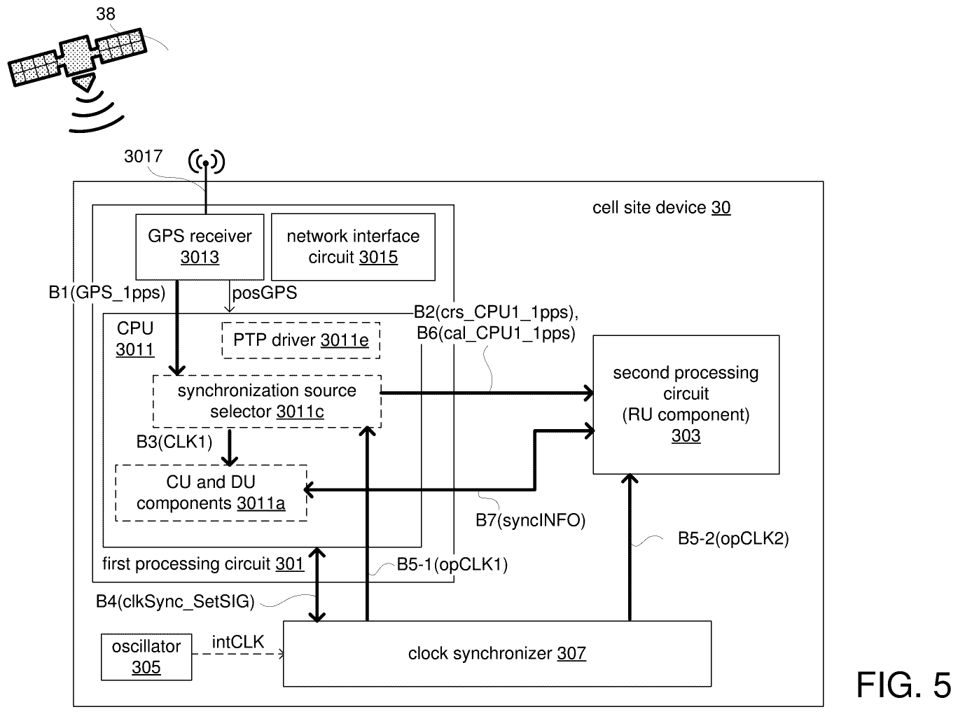

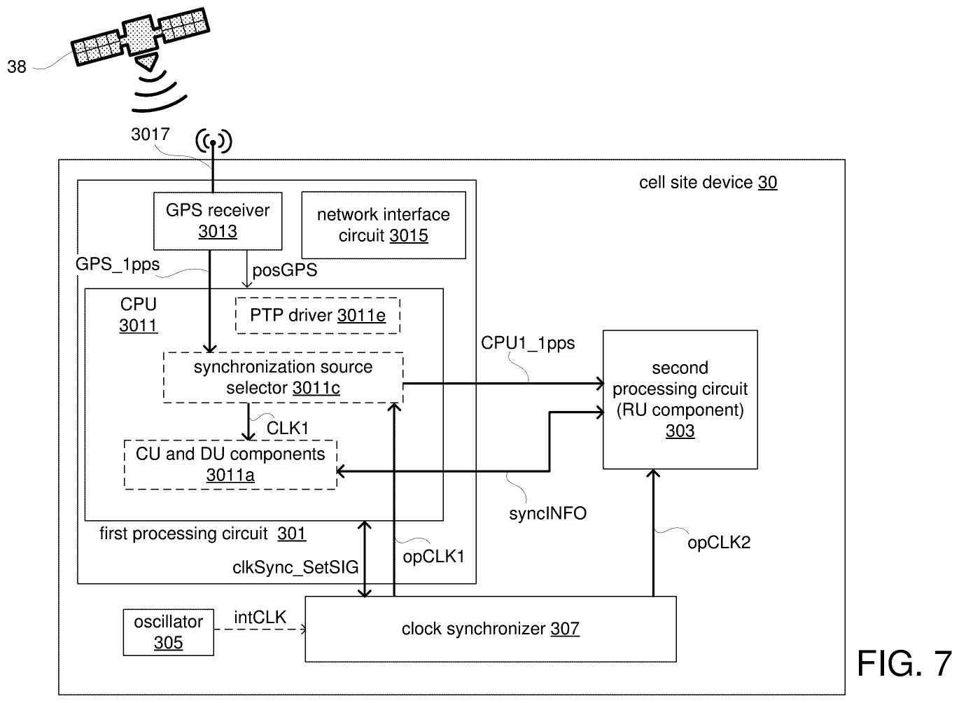

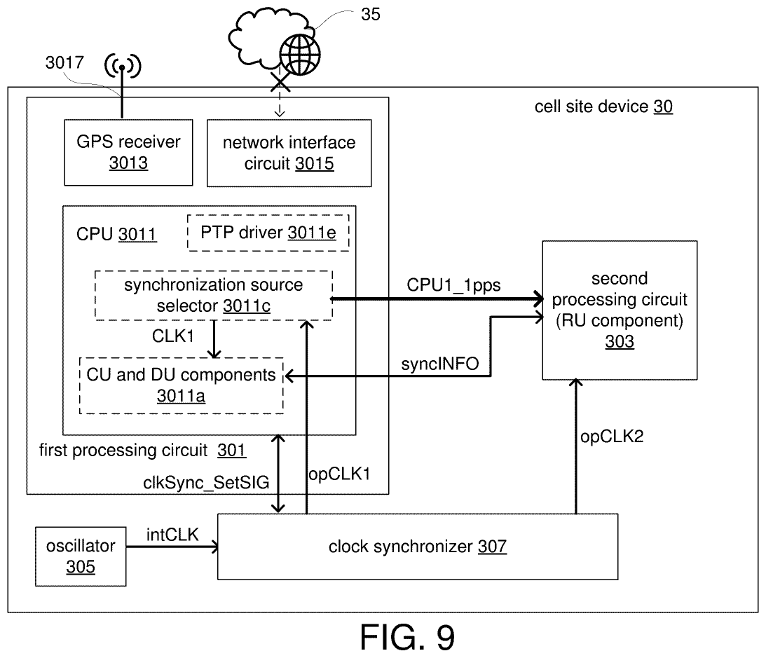

TABLE 1

| | | | | description | |
|---|---|---|---|---|---|
| | state | | transition | of transition | |
| State | description | drawings | direction | direction | next state |
| STG1: | Oscillator | FIG. 4 | dotAR1a | GPS signal | STG2-1: |
| system | 305 is | | | GPS_SIG | initialization |
| initialization | utilized as a | | | can be | procedure of |
| (sysINIT) | clock | | | successfully | GPS-based |
| | synchronization | | | received. | clock |
| | source, | | | | synchronization |
| | and CU and | | | | (gpsINIT) |
| | DU | | | | |
| | components | | | | |
| | 3011a/RU | | dotAR1b | network | STG3-1: |
| | components | | | signal | initialization |
| | are | | | netSIG can | procedure of |
| | synchronized | | | be | network-based |
| | with the | | | successfully | clock |
| | oscillator | | | received. | synchronization |
| | 305. | | | | (netINIT) |
| STG2-1: | GPS signal | FIG. 5 | dotAR2-1 | initialization | STG2-2: |
| initialization | GPS_SIG is | | | procedure of | GPS-based |
| procedure of | received. | | | GPS-based | clock |
| GPS-based | Device | | | clock | synchronization |
| clock | positioning | | | synchronization | (gpsSYNC) |
| synchronization | information | | | (gpsINIT) is | |
| (gpsINIT) | posGPS and | | | complete, | |
| | GPS-based | | | GPS-based | |
| | periodic | | | clock | |
| | synchronization | | | synchronization | |
| | signal | | | (gpsSYNC) | |
| | GPS_1pps | | | is performed | |
| | are obtained. | | | | |
| STG2-2: | GPS is | FIG. 7 | dotAR2-2a | GPS signal | STG2-2: |
| GPS-based | utilized as | | | GPS_SIG | GPS-based |
| clock | the clock | | | can be | clock |
| synchronization | synchronization | | | successfully | synchronization |
| (gpsSYNC) | source. | | | received. | (gpsSYNC) |
| | The first | | | Continue to | |
| | processing | | | utilize the | |
| | circuit 301 | | | GPS-based | |
| | generates | | | clock | |
| | cross-unit | | | synchronization | |
| | periodic | | | (gpsSYNC). | |
| | synchronization | | dotAR2-2b | GPS signal | STG4: |
| | signal | | | GPS_SIG | oscillator-based |
| | CPU1_1pps | | | cannot be | clock |
| | based on | | | successfully | synchronization |
| | GPS-based | | | received, | (oscSYNC) |
| | periodic | | | and network | |
| | synchronization | | | signal | |
| | signal | | | netSIG | |
| | GPS_1pps. | | | cannot be | |
| | | | | successfully | |
| | | | | received. | |
| | | | | Switch to | |
| | | | | utilize the | |
| | | | | oscillator-based | |
| | | | | clock | |
| | | | | synchronization | |
| | | | | (oscSYNC). | |
| | | | dotAR2-2c | GPS signal | STG3-1: |
| | | | | GPS_SIG | initialization |
| | | | | cannot be | procedure of |
| | | | | successfully | network-based |
| | | | | received, | clock |
| | | | | and network | synchronization |
| | | | | signal | (netINIT) |
| | | | | netSIG can | |
| | | | | be | |
| | | | | successfully | |
| | | | | received. | |
| | | | | Switch to | |
| | | | | utilize the | |
| | | | | network-based | |
| | | | | clock | |
| | | | | synchronization | |
| | | | | (netSYNC). | |
| STG3-1: | Network | FIGS. | dotAR3-1 | initialization | STG3-2: |
| initialization | signal | 6A and | | procedure of | network-based |
| procedure of | netSIG is | 6B | | network-based | clock |
| network-based | received. | | | clock | synchronization |
| clock | PTP packets | | | synchronization | (netSYNC) |
| synchronization | PTP_PKT/ | | | (netINIT) | |
| (netINIT) | syncE clock | | | is complete, | |
| | signal | | | and | |
| | syncE_CLK | | | network-based | |
| | is available. | | | clock | |
| | | | | synchronization | |
| | | | | (netSYNC) | |
| | | | | is | |
| | | | | performed. | |
| STG3-2: | PTP/syncE | FIGS. | dotAR3-2a | GPS signal | STG3-2: |
| network-based | is utilized as | 8A and | | GPS_SIG | network-based |
| clock | the clock | 8B | | cannot be | clock |
| synchronization | synchronization | | | successfully | synchronization |
| (netSYNC) | source. | | | received, | (netSYNC) |
| | The first | | | and network | |
| | processing | | | signal | |
| | circuit 301 | | | netSIG can | |
| | generates | | | be | |
| | cross-unit | | | successfully | |
| | periodic | | | received. | |
| | synchronization | | | Continue to | |
| | signal | | | utilize | |
| | CPU1_1pps | | | network-based | |
| | based on | | | clock | |
| | PTP packets | | | synchronization | |
| | PTP PKT/ | | | (netSYNC). | |
| | syncE clock | | dotAR3-2b | None of the | STG4: |
| | signal | | | GPS signal | oscillator-based |
| | syncE_CLK. | | | GPS_SIG | clock |
| | | | | and network | synchronization |
| | | | | signal | (oscSYNC) |
| | | | | netSIG can | |
| | | | | be | |
| | | | | successfully | |
| | | | | received. | |
| | | | | Switch to | |
| | | | | utilize the | |
| | | | | oscillator-based | |
| | | | | clock | |
| | | | | synchronization | |
| | | | | (oscSYNC). | |
| | | | dotAR3-2c | GPS signal | STG2-1: |
| | | | | GPS_SIG | initialization |
| | | | | can be | procedure of |
| | | | | successfully | GPS-based |
| | | | | received. | clock |
| | | | | Switch to | synchronization |
| | | | | GPS-based | (gpsINIT) |
| | | | | clock | |
| | | | | synchronization | |
| | | | | (gpsSYNC) | |
| | | | | regardless | |
| | | | | of the | |
| | | | | availability of | |
| | | | | network | |
| | | | | signal | |
| | | | | netSIG. | |
| STG4: | None of the | FIG. 9 | dotAR4a | GPS signal | STG2-1: |
| oscillator-based | GPS signal | | | GPS_SIG | initialization |
| clock | GPS_SIG | | | can be | procedure of |
| synchronization | and network | | | successfully | GPS-based |
| (oscSYNC) | signal | | | received. | clock |
| | netSIG is | | | Switch to | synchronization |
| | available. | | | utilize | (gpsINIT) |
| | The | | | GPS-based | |
| | oscillator | | | clock | |
| | 305 is | | | synchronization | |
| | utilized as a | | | (gpsSYNC), | |
| | clock | | | regardless | |
| | synchronization | | | of the | |
| | source. | | | availability of | |
| | | | | network | |
| | | | | signal | |
| | | | | netSIG. | |
| | | | dotAR4b | GPS signal | STG3-1: |
| | | | | GPS_SIG | initialization |
| | | | | cannot be | procedure of |
| | | | | successfully | network-based |
| | | | | received, | clock |
| | | | | and network | synchronization |
| | | | | signal | (netINIT) |
| | | | | netSIG can | |
| | | | | be | |
| | | | | successfully | |
| | | | | received. | |
| | | | | Switch to | |
| | | | | utilize | |
| | | | | network-based | |
| | | | | clock | |
| | | | | synchronization | |
| | | | | (netSYNC). | |
| | | | dotAR4c | None of the | STG4: |
| | | | | GPS signal | oscillator-based |
| | | | | GPS_SIG | clock |
| | | | | and network | synchronization |
| | | | | signal | (oscSYNC) |
| | | | | netSIG can | |
| | | | | be | |
| | | | | successfully | |
| | | | | received. | |
| | | | | Continue to | |
| | | | | utilize the | |
| | | | | oscillator-based | |
| | | | | clock | |
| | | | | synchronization | |
| | | | | (oscSYNC). | |

In practical applications, even though the quality of the GPS signal GPS_SIG and the network condition in the environment may change, the synchronization source selector 3011c can always maintain the specific synchronous relationship between the first processing circuit 301 and the second processing circuit 303 based on the state diagram in FIG. 3.

In the following, how the cell site device 30 creates and maintains the specific synchronous relationship is explained in FIGS. 4-9. In FIGS. 4-9, bold arrows are labeled with symbols and numbers to represent the signal creation sequence. Table 2 compares the specific synchronous relationship described in FIGS. 4-9.

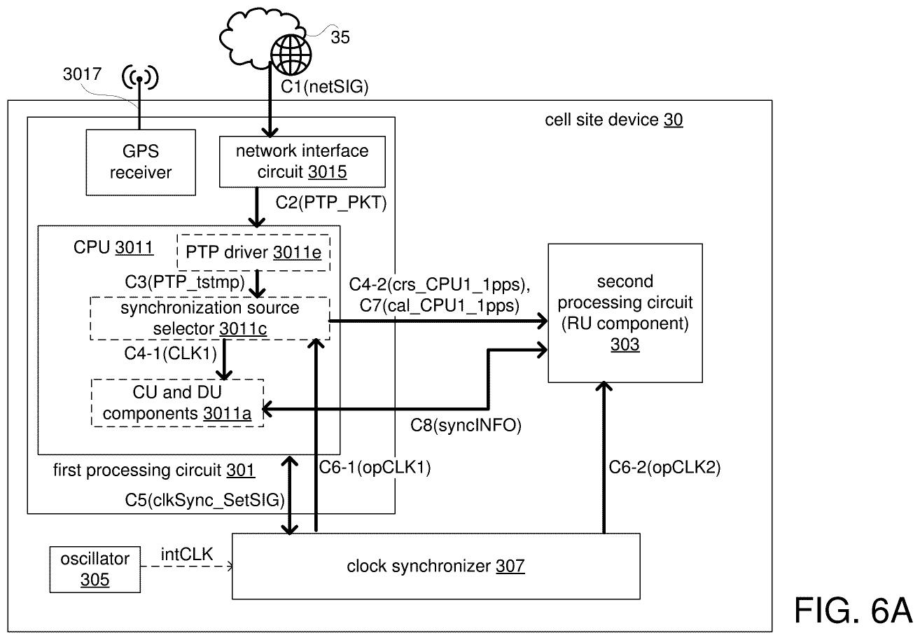

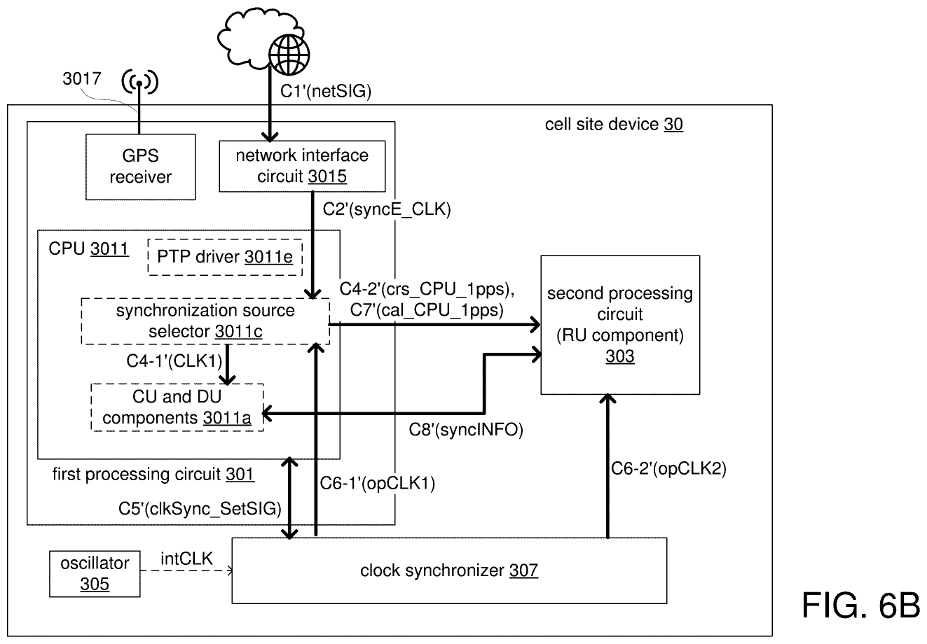

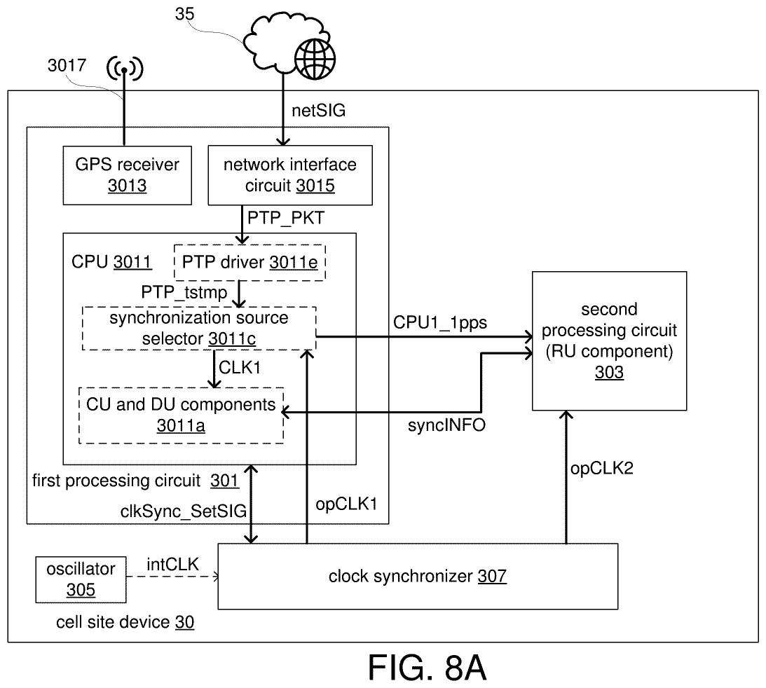

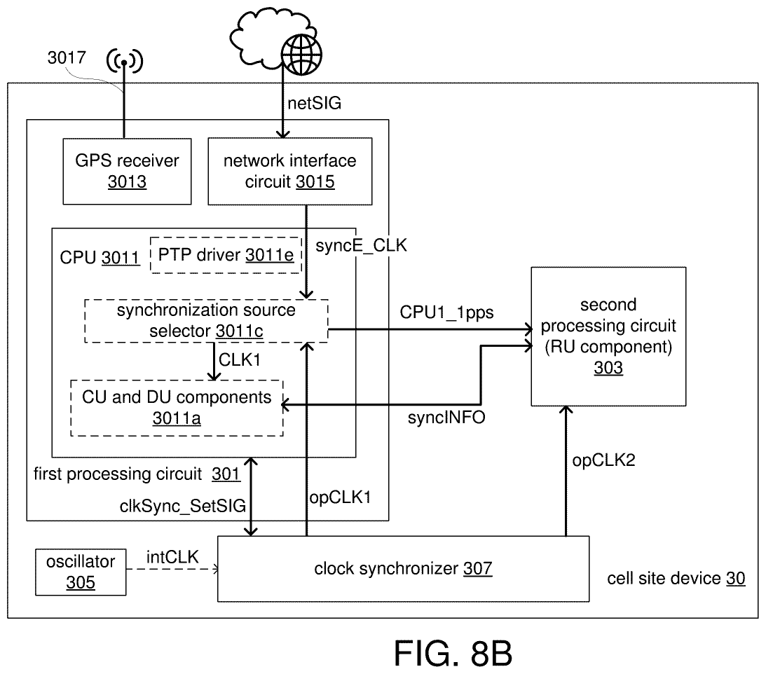

TABLE 2

| | clock synchronization source | | | |
|---|---|---|---|---|
| | | | | oscillator |
| | GPS | PTP | syncE | 305 |
| creation of the | FIG. 5 | FIG. 6A | FIG. 6B | FIG. 4 |
| specific | | | | |
| synchronous | | | | |
| relationship | | | | |
| normal operation | FIG. 7 | FIG. 8A | FIG. 8B | FIG. 9 |
| of the specific | | | | |
| synchronous | | | | |
| relationship | | | | |

FIG. 4 is a schematic diagram illustrating that an oscillator is utilized as the clock synchronization source during the system initialization state. Firstly, the oscillator 305 generates and provides an internal clock signal intCLK to the clock synchronizer 307 (bold arrow A1). Then, according to the internal clock signal intCLK, the clock synchronizer 307 generates the first operation clock opCLK1 (for example, 125 MHZ) and the second operation clock opCLK2 (for example, 122.88 MHz). The frequency of the first operation clock opCLK1 is higher than the frequency of the second operation clock opCLK2, and the frequency of the second operation clock opCLK2 is higher than the frequency of the internal clock signal intCLK.

The clock synchronizer 307 transmits the first operation clock opCLK1 to the synchronization source selector 3011c (bold arrow A2-1) and transmits the second operation clock opCLK2 to the second processing circuit 303 (bold arrow A2-2). As both the first operation clock opCLK1 and the second operation clock opCLK2 are generated by the clock synchronizer 307, the first operation clock opCLK1 and the second operation clock opCLK2 belong to the same clock domain.

For the sake of illustration, the clocks being derived from an identical clock source are defined as having a specific synchronous relationship in the specification, regardless of their actual frequencies. For example, the first operation clock opCLK1 and the second operation clock opCLK2 are considered as having a specific synchronous relationship because they are derived from the same clock source, that is, the internal clock signal intCLK.

After receiving the first operation clock opCLK1, the synchronization source selector 3011c selects the first operation clock opCLK1 to be the processing-circuit clock CLK1 and transmits the processing-circuit clock CLK1 to the CU and DU components 3011a (bold arrow A3). Then, the first processing circuit 301 transmits a synchronizer setting signal clkSync_SetSIG to the clock synchronizer 307 via a serial peripheral interface (hereinafter, SPI).

Via the synchronizer setting signal clkSync_SetSIG, the CPU 3011 can calibrate the clock-related settings of the clock synchronizer 307. Meanwhile, the clock synchronizer 307 can also use the synchronizer setting signal clkSync_SetSIG to report its clock-related settings and/or clock status information to the first processing circuit 301 (bold arrow A4).

After the CPU 3011 and the clock synchronizer 307 exchange the clock-related settings via the synchronizer setting signal clkSync_SetSIG, the clock synchronizer 307 respectively transmits the first operation clock opCLK1 and the second operation clock opCLK2, as having the specific synchronous relationship, to the synchronization source selector 3011c and the second processing circuit 303 (bold arrows A5-1, A5-2).

To ensure traffic between the DU component and the RU component is always synchronized, the synchronization source selector 3011c transmits the cross-unit periodic synchronization signal CPU1_1pps to the RU component (bold arrow A6). The cross-unit periodic synchronization signal CPU1_1pps is a hardware-based (physical) signal generated once per second, and the cross-unit periodic synchronization signal CPU1_1pps is synchronized with the first operation clock opCLK1 and the second operation clock opCLK2.

According to an embodiment of the present disclosure, the CU and DU components 3011a are performed by the first processing circuit 301, and the first processing circuit 301 operates based on the processing-circuit clock CLK1. On the other hand, the RU component is performed by the second processing circuit 303, and the second processing circuit 303 operates based on the operation clock opCLK2.

As the processing-circuit clock CLK1 and the operation clock opCLK2 both originate from the clock synchronizer 307, the specific synchronous relationship between the processing-circuit clock CLK1 and the operation clock opCLK2 is ensured. Accordingly, the CU and DU components 3011a can freely exchange synchronization-related information syncINFO with the RU component (bold arrow A7).

FIG. 4 represents the initialization procedure of the cell site device 30. After the initialization procedure, the specific synchronous relationship between the first processing circuit 301 and the second processing circuit 303 is built based on oscillator 305. According to an embodiment of the present disclosure, the oscillator 305 is always ON as long as the cell site device 30 is in operation. In other words, the oscillator 305 continuously generates the internal clock signal intCLK, regardless of whether the oscillator 305 is selected as the clock synchronization source or not.

FIG. 5 is a schematic diagram illustrating that the device positioning information posGPS can be acquired from the GPS signal GPS_SIG so that the synchronization source selector knows that the GPS-based periodic synchronization signal GPS_1pps can be utilized for clock synchronization. The cell site device 30 utilizes the GPS antenna 3017 to receive the GPS signal GPS_SIG from a GPS satellite. After receiving the GPS signal GPS_SIG, the GPS antenna 3017 generates and conducts a GPS interface signal to the GPS receiver 3013. Through the GPS signal GPS_SIG, the GPS satellite provides a GPS master clock and device positioning information posGPS to the cell site device 30.

If the GPS receiver 3013 can successfully receive device positioning information posGPS, the GPS receiver 3013 transmits the device positioning information posGPS to the first processing circuit 301 via a universal asynchronous receiver/transmitter (UART) interface. Details about using the device positioning information posGPS are omitted.

Once the CPU 3011 receives the device positioning information posGPS from the GPS receiver 3013, the CPU 3011 knows that the GPS-based periodic synchronization signal GPS_1pps is available. The GPS-based periodic synchronization signal GPS_1pps is a hardware-based (physical) signal generated once per second. Then, the GPS receiver 3013 periodically generates the GPS-based periodic synchronization signal GPS_1pps according to the GPS signal GPS_SIG (bold arrow B1).

According to the GPS-based periodic synchronization signal GPS_1pps, the synchronization source selector 3011c periodically issues a coarse cross-unit periodic synchronization signal crs_CPU1_1pps to the second processing circuit 303 (bold arrow B2). The coarse cross-unit periodic synchronization signal crs_CPU1_1pps is a hardware-based signal generated once per second, and the coarse cross-unit periodic synchronization signal crs_CPU1_1pps is synchronized with the GPS-based periodic synchronization signal GPS_1pps. Based on the GPS-based periodic synchronization signal GPS_1pps, the synchronization source selector 3011c generates and provides the processing-circuit clock CLK1 to the CU and DU components 3011a (bold arrow B3).

Then, via the synchronizer setting signal clkSync_SetSIG, the CPU 3011 can fine-tune the clock-related settings of the clock synchronizer 307. Meanwhile, the clock synchronizer 307 can report its clock-related settings and/or clock status information to the first processing circuit 301 (bold arrow B4). By communicating with the clock synchronizer 307 via the synchronizer setting signal clkSync_SetSIG, the first processing circuit 301 calibrates the cross-unit periodic synchronization signal cal_CPU1_1pps to synchronize the cross-unit periodic synchronization signal cal_CPU1_1pps and the first operation clock opCLK1.

After the CPU 3011 and the clock synchronizer 307 exchange the clock-related settings via the synchronizer setting signal clkSync_SetSIG, the clock synchronizer 307 respectively transmits the first operation clock opCLK1 and the second operation clock opCLK2 to the synchronization source selector 3011c and the second processing circuit 303 (bold arrows B5-1, B5-2).

To ensure traffic between the DU component and the RU component is always synchronized, the synchronization source selector 3011c transmits a calibrated cross-unit periodic synchronization signal cal_CPU1_1pps to the RU component 303a (bold arrow B6). The calibrated cross-unit periodic synchronization signal cal_CPU1_1pps is a hardware-based signal generated once per second, and the calibrated cross-unit periodic synchronization signal cal_CPU1_1pps is synchronized with the first operation clock opCLK1 and the second operation clock opCLK2.

According to an embodiment of the present disclosure, the CU and DU components 3011a are performed by the first processing circuit 301, and the first processing circuit 301 operates based on the processing-circuit clock CLK1. On the other hand, the RU component is performed by the second processing circuit 303, and the second processing circuit 303 operates based on the second operation clock opCLK2.

As the processing-circuit clock CLK1 and the second operation clock opCLK2 both originate from the clock synchronizer 307, and the cross-unit periodic synchronization signal cal_CPU1_1pps has been calibrated, the specific synchronous relationship between the processing-circuit clock CLK1 and the second operation clock opCLK2 is ensured. Accordingly, the CU and DU components 3011a can freely exchange synchronization-related information syncINFO with the RU component (bold arrow B7).

Please refer to step2-1 in FIG. 3 and FIG. 5 together. After the initialization procedure of the GPS-based clock synchronization in FIG. 5 is complete, the cell site device 30 continues to perform the GPS-based clock synchronization in FIG. 7.

Please note that the oscillator 305 continues to provide the internal clock signal intCLK to the clock synchronizer 307 in FIG. 5, even though the clock synchronizer 307 does not further utilize the internal clock signal intCLK for generating the first operation clock opCLK1 and the second operation clock opCLK2. Alternatively, the continuous generation of the internal clock signal intCLK can be considered as an operation performed in the background.

The cell site device 30 may be placed in an indoor or outdoor environment. In either environment, the GPS signal GPS_SIG may be weak, so the GPS receiver 3013 is incapable of generating the device positioning information posGPS. Then, an alternate choice is adopted by using the network signal netSIG (for example, Ethernet signal) as another media that carries synchronization-related information. The synchronization-related information carried by the network signal netSIG can be packet-based (for example, PTP) or physical-layer-based (for example, syncE).

The network interface circuit 3015 is utilized to assist the synchronization source selector 3011c in acquiring the synchronization-related information carried by the network signal netSIG. Details regarding how the network interface circuit 3015 assists the synchronization source selector 3011c to acquire the synchronization-related information are omitted in the present disclosure.

FIG. 6A is a schematic diagram illustrating that the PTP timestamps PTP_tstmp can be acquired from the network signal netSIG, and the synchronization source selector determines to use the PTP-based clock synchronization. The cell site device 30 utilizes the network interface circuit 3015 to receive the network signal netSIG (bold arrow C1). Then, the network interface circuit 3015 acquires PTP packets PTP_PKT from the network signal netSIG (bold arrow C2).

According to the PTP packets PTP_PKT, the PTP driver 3011e generates PTP timestamps PTP_tstmp. The PTP driver 3011e transmits the PTP timestamps PTP_tstmp to the synchronization source selector 3011c (bold arrow C3). According to the PTP timestamps PTP_tstmp, the synchronization source selector 3011c issues the processing-circuit clock CLK1 to the CU and DU components 3011a (bold arrow B3 (blocked arrow C4-1) and issues a coarse cross-unit periodic synchronization signal crs_CPU1_1pps to the second processing circuit 303 (bold arrow C4-2).

Then, via the synchronizer setting signal clkSync_SetSIG, the CPU 3011 can fine-tune the timing/frequency/phase of the first operation clock opCLK1 and the second operation clock opCLK2, by adjusting the clock-related settings of the clock synchronizer 307. Meanwhile, the clock synchronizer 307 can report its clock-related settings and/or clock status information to the first processing circuit 301 (bold arrow C5).

After the CPU 3011 and the clock synchronizer 307 exchange the clock-related settings via the synchronizer setting signal clkSync_SetSIG, the clock synchronizer 307 respectively transmits the first operation clock opCLK1 and the second operation clock opCLK2 to the synchronization source selector 3011c and the second processing circuit 303 (bold arrows C6-1, C6-2).

To ensure traffic between the DU component and the RU component is always synchronized, the synchronization source selector 3011c transmits a calibrated cross-unit periodic synchronization signal cal_CPU1_1pps to the RU component 303a (bold arrow C7). The calibrated cross-unit periodic synchronization signal cal_CPU1_1pps is a hardware-based signal generated once per second, and the calibrated cross-unit periodic synchronization signal cal_CPU1_1pps is synchronized with the first operation clock opCLK1 and the second operation clock opCLK2.

According to an embodiment of the present disclosure, the CU and DU components 3011a are performed by the first processing circuit 301, and the first processing circuit 301 operates based on the processing-circuit clock CLK1. On the other hand, the RU component is performed by the second processing circuit 303, and the second processing circuit 303 operates based on the second operation clock opCLK2.

As the processing-circuit clock CLK1 and the second operation clock opCLK2 both originate from the clock synchronizer 307, the specific synchronous relationship between the processing-circuit clock CLK1 and the second operation clock opCLK2 is ensured. Accordingly, the CU and DU components 3011a can freely exchange synchronization-related information syncINFO with the RU component (bold arrow C8).

Please refer to step3-1 in FIG. 3 and FIG. 6A together. After the initialization procedure of the PTP-based clock synchronization in FIG. 6A is complete, the cell site device 30 continues to perform the PTP-based clock synchronization in FIG. 8A.

Please note that the oscillator 305 continues to provide the internal clock signal intCLK to the clock synchronizer 307 in FIG. 6A, even though the clock synchronizer 307 does not further utilize the internal clock signal intCLK for generating the first operation clock opCLK1 and the second operation clock opCLK2. Alternatively, the existence and continuous generation of the internal clock signal intCLK can be considered as an operation performed in the background.

FIG. 6B is a schematic diagram illustrating that the syncE clock signal syncE_CLK can be acquired from the network signal netSIG and the synchronization source selector determines to use the syncE-based clock synchronization. The cell site device 30 utilizes the network interface circuit 3015 to receive the network signal netSIG (bold arrow C1′). Then, the network interface circuit 3015 acquires the syncE clock signal syncE_CLK from the network signal netSIG (bold arrow C2′).

According to the syncE clock signal syncE_CLK, the synchronization source selector 3011c issues the processing-circuit clock CLK1 to the CU and DU components 3011a (bold arrow B3 (blocked arrow C4-1′) and issues a coarse cross-unit periodic synchronization signal crs_CPU1_1pps to the second processing circuit 303 (bold arrow C4-2′).

Then, via the synchronizer setting signal clkSync_SetSIG, the CPU 3011 can fine-tune the clock-related settings of the clock synchronizer 307. Meanwhile, the clock synchronizer 307 can report its clock-related settings and/or clock status information to the first processing circuit 301 (bold arrow C5′).

After the CPU 3011 and the clock synchronizer 307 exchange the clock-related settings via the synchronizer setting signal clkSync_SetSIG, the clock synchronizer 307 respectively transmits the first operation clock opCLK1 and the second operation clock opCLK2 to the synchronization source selector 3011c and the second processing circuit 303 (bold arrows C6-1, C6-2).

To ensure traffic between the DU component and the RU component is always synchronized, the synchronization source selector 3011c transmits a calibrated cross-unit periodic synchronization signal cal_CPU1_1pps to the RU component 303a (bold arrow C7′). The calibrated cross-unit periodic synchronization signal cal_CPU1_1pps is a hardware-based signal generated once per second, and the calibrated cross-unit periodic synchronization signal cal_CPU1_1pps is synchronized with the first operation clock opCLK1 and the second operation clock opCLK2.

According to an embodiment of the present disclosure, the CU and DU components 3011a are performed by the first processing circuit 301, and the first processing circuit 301 operates based on the processing-circuit clock CLK1. On the other hand, the RU component is performed by the second processing circuit 303, and the second processing circuit 303 operates based on the second operation clock opCLK2.

As the processing-circuit clock CLK1 and the second operation clock opCLK2 both originate from the clock synchronizer 307, the specific synchronous relationship between the processing-circuit clock CLK1 and the second operation clock opCLK2 is ensured. Accordingly, the CU and DU components 3011a can freely exchange synchronization-related information syncINFO with the RU component (bold arrow C8′).

Please refer to step3-1 in FIG. 3 and FIG. 6B together. After the initialization procedure of the syncE-based clock synchronization in FIG. 6B is complete, and the cell site device 30 continues to perform the syncE-based clock synchronization in FIG. 8B.

Please note that the oscillator 305 continues to provide the internal clock signal intCLK to the clock synchronizer 307 in FIG. 6B, even though the clock synchronizer 307 does not further utilize the internal clock signal intCLK for generating the first operation clock opCLK1 and the second operation clock opCLK2. Alternatively, the generation of the internal clock signal intCLK can be considered as an operation performed in the background.

According to an embodiment of the present disclosure, the cell site device 30 supports internal and external clock synchronization sources. The initialization procedures corresponding to these clock synchronization sources have been described in FIGS. 4, 5, 6A, and 6B. These various clock synchronization sources and their related signals are summarized in Table 3.

TABLE 3

| | | | | |
|---|---|---|---|---|
| Drawings | FIG. 4 | FIG. 5 | FIG. 6A | FIG. 6B |
| representing | | | | |
| the | | | | |
| initialization | | | | |
| procedure | | | | |
| Drawings | FIG. 9 | FIG. 7 | FIG. 8A | FIG. 8B |
| representing | | | | |
| stable | | | | |
| clock | | | | |
| synchronization | | | | |
| state | | | | |
| clock | oscillator 305 | GPS signal | PTP signal | syncE signal |
| synchronization | (internal) | (external) | (external) | (external) |
| source | | | | |
| signals | processing- | device | network signal | network signal |
| related to | circuit clock | positioning | netSIG, PTP | netSIG, syncE |
| clock | CLK1, | information | packets | clock signal |
| synchronization | cross-unit | posGPS, | PTP_PKT, | syncE_CLK, |
| | periodic | GPS-based | PTP | processing- |
| | synchronization | periodic | timestamps | cciruit clock |
| | signal | synchronization | PTP_tstmp, | CLK1, |
| | CPU1_1pps, | signal | processing-cir | cross-unit |
| | first operation | GPS_1pps, | cuit clock | periodic |
| | clock opCLK1, | processing- | CLK1, | synchronization |
| | second | circuit clock | cross-unit | signal |
| | operation | CLK1, | periodic | CPU1_1pps, |
| | clock opCLK2, | cross-unit | synchronization | first operation |
| | synchronizer | periodic | signal | clock opCLK1, |
| | setting signal | synchronization | CPU1_1pps, | second |
| | clkSync_SetSIG, | signal | first operation | operation |
| | synchronization- | CPU1_1pps, | clock opCLK1, | clock opCLK2, |
| | related | first operation | second | synchronizer |
| | information | clock opCLK1, | operation | setting signal |
| | syncINFO, | second | clock opCLK2, | clkSync_SetSIG, |
| | internal clock | operation | synchronizer | synchronization- |
| | signal intCLK | clock opCLK2, | setting signal | related |
| | | synchronizer | clkSync_SetSIG, | information |
| | | setting signal | synchronization- | syncINFO |
| | | clkSync_SetSIG, | related | |
| | | synchronization- | information | |
| | | related | syncINFO | |
| | | information | | |
| | | syncINFO | | |

In the following, the stable synchronization states corresponding to these clock synchronization sources will be illustrated in FIGS. 7, 8A, 8B, and 8C.

FIG. 7 is a schematic diagram illustrating that the cell site device is in the stable clock synchronization state using GPS-based clock synchronization. Please refer to FIGS. 5 and 7 together. The signals related to the GPS-based clock synchronization, including the device positioning information posGPS, the GPS-based periodic synchronization signal GPS_1pps, the processing-circuit clock CLK1, the cross-unit periodic synchronization signal CPU1_1pps, the first operation clock opCLK1, the second operation clock opCLK2, the synchronizer setting signal clkSync_SetSIG, and the synchronization-related information syncINFO, as explained in FIG. 5, are redrawn in FIG. 7. In short, the signals related to the GPS-based clock synchronization jointly become a stable circulation as long as the cell site device 30 continuously uses the GPS signal GPS_SIG as the clock synchronization source.

FIG. 8A is a schematic diagram illustrating that the cell site device is in the stable clock synchronization state using the PTP-based clock synchronization. Please refer to FIGS. 6A and 8A together. The signals related to the PTP-based clock synchronization, including the network signal netSIG, the PTP packets PTP_PKT, the PTP timestamps PTP_tstmp, the processing-circuit clock CLK1, the cross-unit periodic synchronization signal CPU1_1pps, the first operation clock opCLK1, the second operation clock opCLK2, the synchronizer setting signal clkSync_SetSIG, and the synchronization-related information syncINFO, as explained in FIG. 6A, are redrawn in FIG. 8A. In short, the signals related to the PTP-based clock synchronization jointly become a stable circulation as long as the cell site device 30 continuously uses the PTP as the clock synchronization source.

FIG. 8B is a schematic diagram illustrating that the cell site device is in the stable clock synchronization state using the syncE-based clock synchronization. Please refer to FIGS. 6B and 8B together. The signals related to the syncE-based clock synchronization, including the network signal netSIG, the syncE clock signal syncE_CLK, the processing-circuit clock CLK1, the cross-unit periodic synchronization signal CPU1_1pps, the first operation clock opCLK1, the second operation clock opCLK2, the synchronizer setting signal clkSync_SetSIG, and the synchronization-related information syncINFO, as explained in FIG. 6B, are redrawn in FIG. 8B. In short, the signals related to the syncE-based clock synchronization jointly become a stable circulation as long as the cell site device 30 continuously uses the syncE as the clock synchronization source.

As mentioned above, generation of the internal clock signal intCLK is still performed in the background in FIGS. 7, 8A, and 8B. According to an embodiment of the present disclosure, even if the cell site device 30 suddenly encounters situations where GPS/network signals are unavailable/invalid, the synchronization relationship between the CU and DU components 3011a and the RU component can be maintained because of the internal clock signal intCLK generated in the background.

With the internal clock signal intCLK generated in the background, the synchronization relationship between the CU and DU components 3011a and the RU component is not interrupted when the cell site device 30 encounters unexpected changes, such as suddenly losing the GPS signal GPS_SIG and/or the network signal netSIG.

While waiting for qualities of the GPS signal GPS_SIG/network signal netSIG to recover, clocks of the CU and DU components 3011a and the RU component can remain having the specific synchronous relationship as the oscillator 305 is always available as a backup clock synchronization source.

FIG. 9 is a schematic diagram illustrating that the cell site device is in the stable clock synchronization state using oscillator-based clock synchronization. In FIG. 9, it is assumed that none of the GPS signal GPS_SIG and the network signal netSIG is available, so the synchronization source selector 3011c chooses the oscillator 305 as the clock synchronization source.

Please refer to FIGS. 4 and 9 together. The signals related to the oscillator-based clock synchronization, as explained in FIG. 4, are redrawn in FIG. 9. In short, the signals related to the oscillator-based clock synchronization, including the processing-circuit clock CLK1, the cross-unit periodic synchronization signal CPU1_1pps, the first operation clock opCLK1, the second operation clock opCLK2, the synchronizer setting signal clkSync_SetSIG, the synchronization-related information syncINFO, and the internal clock signal intCLK, jointly become a stable circulation. This stable circulation is always ready to be utilized when none of the external clock synchronization sources is available/valid.

As the oscillator 305 is an internal component of the cell site device 30, the oscillator 305 can consistently provide the internal clock signal intCLK to the clock synchronizer 307. Accordingly, the specific synchronous relationship between the first operation clock opCLK1 and second operation clock opCLK2 can be assured even when the synchronization source selector 3011c changes the clock synchronization source of the cell site device 30 or when the signal quality of the external clock synchronization source becomes worse.

As multiple clock synchronization sources are adopted, the synchronization relationship between the first processing circuit 301 and the second processing circuit 303 is maintained. The clock synchronization source being selected by the synchronization source selector is dynamically determined, depending on the availability of the clock synchronization sources. For example, the clock synchronization source can be GNSS-based, a packet-based clock synchronization such as PTP protocol, a physical-layer-based clock synchronization, an oscillator 305, and so forth.

In Table 4, the duration required for being synchronized with the external clock synchronization source and the accuracy of precision in comparison with the external clock synchronization source are compared.

TABLE 4

| | | | | |
|---|---|---|---|---|
| clock | oscillator | GPS signal | PTP signal | syncE signal |
| synchronization | 305 | (external) | (external) | (external) |
| source | (internal) | | | |
| duration | fastest | slowest | medium | medium |
| required for | (not | (a few minutes | (few minutes) | (few minutes) |
| being | applicable) | to a few | | |
| synchronized | | hours) | | |
| with the | | | | |
| external clock | | | | |
| synchronization | | | | |
| source | | | | |
| accuracy of | lowest | highest | second | second lowest |
| precision | (not | (nanosecond) | highest | (microsecond) |
| (potential error | applicable) | | (nanosecond) | |
| in comparison | | | | |
| with external | | | | |
| clock | | | | |
| synchronization | | | | |
| source) | | | | |
| selection | last | first | second | third |
| priority | | | | |

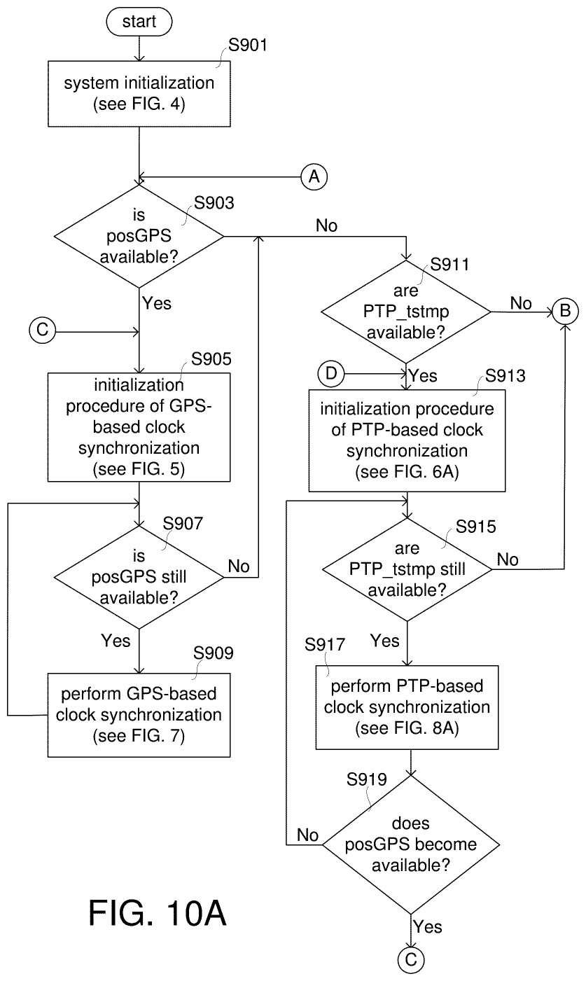

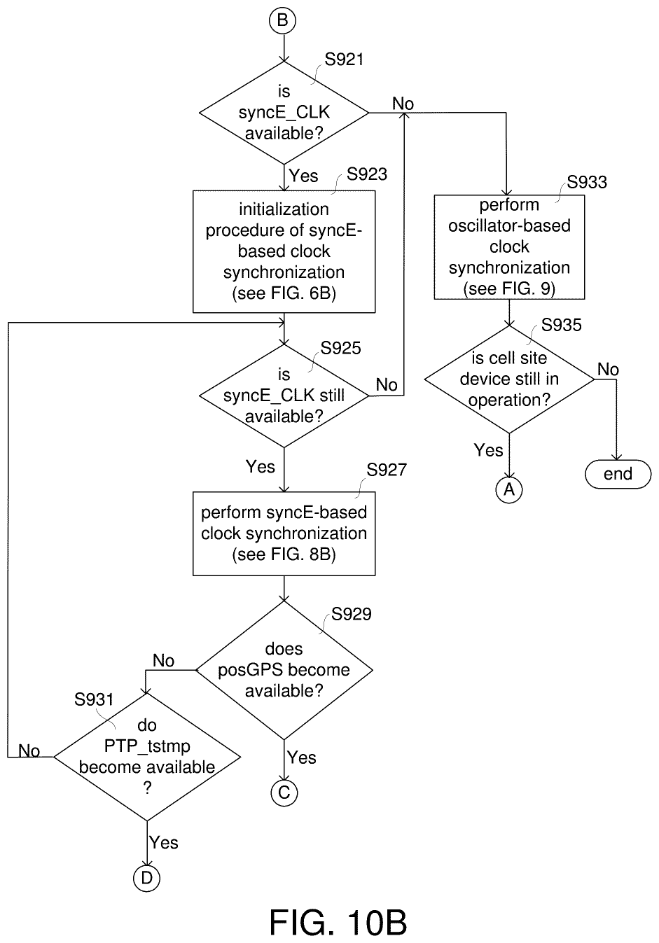

As summarized in Table 4, the precision of using GPS-based clock synchronization is the highest. Thus, the synchronization source selector 3011c would select the GPS-based clock synchronization whenever the GPS signal GPS_SIG is available. However, the duration required for GPS-based clock synchronization is also the slowest, so the synchronization source selector 3011c needs to be able to change to other clock sources if the GPS signal GPS_SIG becomes weak or interrupted. Based on a similar selection strategy, the synchronization source selector 3011c can dynamically select and change the clock synchronization source of the cell site device 30 based on FIGS. 10A and 10B.

FIGS. 10A and 10B are flow diagrams schematically illustrating how the cell site device, according to an embodiment of the present disclosure, switches the clock synchronization source. Please refer to FIGS. 4-10 together.

Firstly, the system initialization of the cell site device 30 is performed (step S901). Details about step S901 can be referred to FIG. 4. After step S901 is complete, the internal clock signal intCLK is continuously generated in the background. Then, the synchronization source selector 3011c checks if the device positioning information posGPS is available (step S903).

If the determination result of step S903 is positive, the initialization procedure of GPS-based clock synchronization is performed (step S905). Details about step S905 can be referred to FIG. 5.

After step S905, the synchronization source selector 3011c again checks if the device positioning information posGPS is still available (step S907). If the determination result of step S907 is positive, the cell site device 30 continues to utilize the GPS-based periodic synchronization signal GPS_1pps to perform the GPS-based clock synchronization (step S909). Details about step S909 can be referred to FIG. 7. Steps S907 and S909 are repetitively performed until the determination result of step S907 is negative.

In a poor GPS environment, the GPS receiver 3013 cannot receive the GPS signal GPS_SIG through the GPS antenna, and the GPS-based periodic synchronization signal GPS_1pps is unavailable/invalid. This is the situation when the determination result of step S903 is negative or when the determination result of step S907 is negative.

Under such circumstances, the synchronization source selector 3011c needs to check if the PTP timestamps PTP_tstmp are available (step S911). If the determination result of step S911 is positive, the initialization procedure of PTP-based clock synchronization is performed (step S913). Details about step S913 can be referred to FIG. 6A.

After step S913, the synchronization source selector 3011c again checks if the PTP timestamps PTP_tstmp remain available (step S915). If the determination result of step S915 is positive, the cell site device 30 continues to perform the PTP-based clock synchronization (step S917). Details about step S917 can be referred to FIG. 8A.

After step S917, the synchronization source selector 3011c checks if the device positioning information posGPS becomes available (step S919). If the determination result of step S919 is negative, the device positioning information posGPS is still not available, and step S915 is repetitively performed to check if the PTP timestamps PTP_tstmp can still be acquired from the network signal netSIG.

On the other hand, if the determination result of step S919 is positive, the synchronization source selector 3011c uses the GPS-based clock synchronization to replace the PTP-based clock synchronization, as the precision accuracy of the GPS-based clock synchronization is better. Thus, step S905 is performed. As the initialization procedure of GPS-based clock synchronization takes time (a few minutes to a few hours), the synchronization source selector 3011c can continue utilizing a PTP-based clock synchronization during the initialization procedure of GPS-based clock synchronization.

When both GPS-based periodic synchronization signal GPS_1pps and PTP timestamps PTP_tstmp are unavailable, the synchronization source selector 3011c checks if the syncE clock signal syncE_CLK is available in the network signal netSIG (step S921). If the determination result of step S921 is positive, the initialization procedure of syncE-based clock synchronization is performed (step S923). Details about step S923 can be referred to FIG. 6B.

After step S923, the synchronization source selector 3011c again checks if the syncE clock signal syncE_CLK is still available (step S925). If the determination result of step S925 is positive, the cell site device 30 continues to perform the syncE-based clock synchronization (step S927). Details about step S927 can be referred to FIG. 8B.

After step S927, the synchronization source selector 3011c checks if the device positioning information posGPS becomes available (step S929). If the determination result of step S929 is positive, the synchronization source selector 3011c uses the GPS-based clock synchronization to replace the syncE-based clock synchronization and step S905 is performed. As the initialization procedure of GPS-based clock synchronization (step S905) takes a while, the synchronization source selector 3011c can continue to utilize a PTP-based clock synchronization during the clock source transition procedure.

If the determination result of step S929 is negative, the synchronization source selector 3011c further checks if the PTP timestamps PTP_tstmp become available (step S931). If the determination result of step S931 is positive, the synchronization source selector 3011c uses the PTP-based clock synchronization to replace the syncE-based clock synchronization and step S913 is performed.

As the initialization procedure of PTP-based clock synchronization (step S913) takes a while, the synchronization source selector 3011c can continue to utilize a syncE-based clock synchronization during the transition procedure of the clock synchronization source. If the determination result of step S931 is negative, step S925 is repetitively performed.

When none of the GPS-based periodic synchronization signal GPS_1pps, the PTP timestamps PTP_tstmp, and the syncE clock signal syncE_CLK is available, the synchronization source selector 3011c performs the oscillator-based clock synchronization (step S933). Details about step S933 can be referred to FIG. 9.

After step S933, the synchronization source selector 3011c checks if the cell site device 30 is still in operation (step S935). If the determination result of S935 is positive, step S903 is repetitively executed. Otherwise, the flow ends.

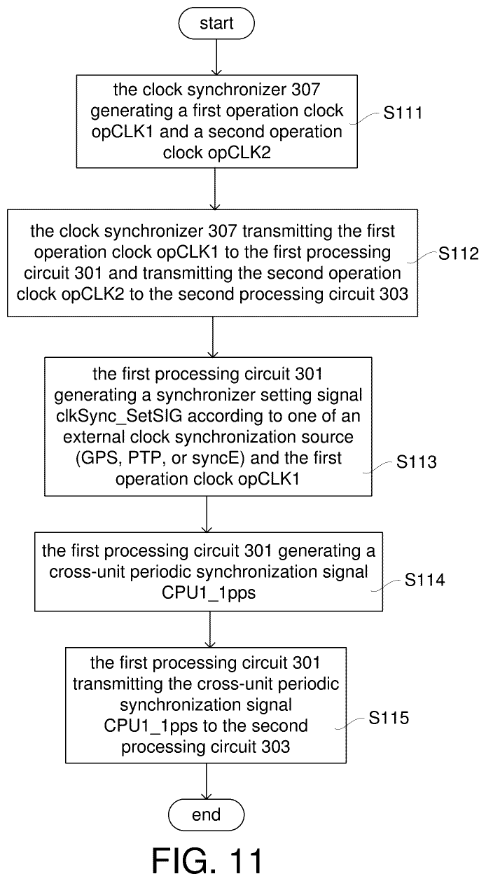

FIG. 11 is a flow diagram schematically illustrating the clock synchronization method applied to the cell site device according to an embodiment of the present disclosure. Firstly, the clock synchronizer 307 generates a first operation clock opCLK1 and a second operation clock opCLK2 (step S111). Then, the clock synchronizer 307 transmits the first operation clock opCLK1 to the first processing circuit 301 and transmits the second operation clock opCLK2 to the second processing circuit 303 (step S112).

The first processing circuit 301 generates the synchronizer setting signal clkSync_SetSIG according to one of the external clock synchronization sources (GPS, PTP, or syncE) and the first operation clock opCLK1 (step S113). Furthermore, the first processing circuit 301 generates a cross-unit periodic synchronization signal CPU1_1pps (step S114) and transmits the cross-unit periodic synchronization signal CPU1_1pps to the second processing circuit 303 (step S115).

As illustrated above, a multiple clock synchronization approach is provided. The multiple clock synchronization approach provides multiple clock synchronization sources. Among these clock synchronization sources, the GPS-based periodic synchronization signal GPS_1pps is the primary choice, the PTP timestamps PTP_tstmp are the secondary choice, the syncE clock signal syncE_CLK is an alternate choice, and the oscillator 305 is a backup choice. As the backup choice, the oscillator 305 is always available for maintaining synchronization between the CU and DU components 3011a and the RU component. Thus, the connections and transmissions between the cell site device 30 and user equipment (UE) are not affected by the clock synchronization source switching.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A cell site device in a radio access network, comprising:
a clock synchronizer, configured to generate a first operation clock and a second operation clock;
a first processing circuit, electrically connected to the clock synchronizer, configured to receive the first operation clock, generate a synchronizer setting signal, transmit the synchronizer setting signal to the clock synchronizer, and generate a cross-unit periodic synchronization signal; and
a second processing circuit, electrically connected to the clock synchronizer and the first processing circuit, configured to receive the second operation clock from the clock synchronizer, and receive the cross-unit periodic synchronization signal from the first processing circuit.

2. The cell site device according to claim 1,
wherein the clock synchronizer adjusts the first operation clock and the second operation clock according to the synchronizer setting signal.

3. The cell site device according to claim 1, further comprising:
an oscillator, electrically connected to the clock synchronizer, configured to provide an internal clock signal to the clock synchronizer.

4. The cell site device according to claim 3, wherein
a frequency of the first operation clock is higher than a frequency of the second operation clock, and
the frequency of the second operation clock is higher than a frequency of the internal clock signal.

5. The cell site device according to claim 1,
wherein the first processing circuit generates the synchronizer setting signal according to an external clock synchronization source if the external clock synchronization source is available,
wherein the first processing circuit generates the synchronizer setting signal according to the first operation clock if the external clock synchronization source is unavailable.

6. The cell site device according to claim 5, wherein the first processing circuit comprises:
a central processing unit, configured to perform a synchronization source selector, a distributed unit component, and a central unit component,
wherein the synchronization source selector provides a processing-circuit clock to the distributed unit component and the central unit component,
wherein the synchronization source selector generates the processing-circuit clock according to the external clock synchronization source if the external clock synchronization source is available,
wherein the synchronization source selector selects the first operation clock to be the processing-circuit clock if the external clock synchronization source is unavailable.

7. The cell site device according to claim 6, wherein the cross-unit periodic synchronization signal is generated once per second.

8. The cell site device according to claim 6,
wherein the external clock synchronization source is one of a global navigation satellite system (GNSS)-based periodic synchronization signal, a plurality of precision time protocol timestamps, and a synchronous Ethernet clock signal.

9. The cell site device according to claim 8, wherein the first processing circuit further comprises:
a GNSS antenna, in communication with at least one GNSS satellite, configured to generate a GNSS interface signal according to a GNSS signal received from the at least one GNSS satellite; and
a GNSS receiver, electrically connected to the GNSS antenna and the central processing unit, configured to receive the GNSS interface signal and generate a GNSS-based periodic synchronization signal.

10. The cell site device according to claim 9, wherein
the GNSS-based periodic synchronization signal is generated once per second.

11. The cell site device according to claim 9, wherein
the synchronization source selector generates the processing-circuit clock according to the GNSS-based periodic synchronization signal if the GNSS receiver generates the GNSS-based periodic synchronization signal.

12. The cell site device according to claim 9, wherein
the GNSS receiver generates a device positioning information according to the GNSS interface signal, and
the GNSS receiver transmits the device positioning information to the first processing circuit via a universal asynchronous receiver/transmitter interface.

13. The cell site device according to claim 9, wherein the first processing circuit further comprises:
a network interface circuit, configured to receive a network signal from a mobile network.

14. The cell site device according to claim 13, wherein
the network signal comprises a precision time protocol packet.

15. The cell site device according to claim 14, wherein
the central processing unit further performs a precision time protocol driver, wherein the precision time protocol driver generates at least one of the plurality of precision time protocol timestamps according to the precision time protocol packet,
wherein when the GNSS receiver does not generate the GNSS-based periodic synchronization signal, the first processing circuit generates the synchronizer setting signal, and the synchronization source selector generates the processing-circuit clock according to the at least one of the plurality of precision time protocol timestamps.

16. The cell site device according to claim 13,
wherein the network signal comprises a synchronous Ethernet clock signal,
wherein when the GNSS receiver does not generate the GNSS-based periodic synchronization signal, the first processing circuit generates the synchronizer setting signal, and the synchronization source selector generates the processing-circuit clock according to the synchronous Ethernet clock signal.

17. The cell site device according to claim 6, wherein
the second processing circuit performs a radio unit component, and the radio unit component exchanges synchronization-related information with the distributed unit component.

18. The cell site device according to claim 1, wherein
the first processing circuit transmits the synchronizer setting signal to the clock synchronizer via a serial peripheral interface.

19. The cell site device according to claim 1, wherein
the cell site device is in communication with a plurality of user equipment.

20. A clock synchronization method applied to a cell site device in a radio access network, wherein the cell site device comprises a clock synchronizer, a first processing circuit, and a second processing circuit, and the clock synchronization method comprises steps of:
the clock synchronizer generating a first operation clock and a second operation clock;
the clock synchronizer transmitting the first operation clock to the first processing circuit and transmitting the second operation clock to the second processing circuit;
the first processing circuit generating a synchronizer setting signal according to one of an external clock synchronization source and the first operation clock;
the first processing circuit generating a cross-unit periodic synchronization signal; and
the first processing circuit transmitting the cross-unit periodic synchronization signal to the second processing circuit.
